(19) United States
(12) Patent Application Publication
(10) Pub. No.: US 2026/0229111 A1
(43) Pub. Date: Aug. 6, 2026

(54) RESCUE DEVICE AND RESCUE METHOD

(71) Applicant: 3M INNOVATIVE PROPERTIES COMPANY, St. Paul, MN (US)

(72) Inventors: William B. Howell, Pineville, NC (US); Darin K. Thompson, Huntersville, NC (US); Richard J. Sabacinski, Charlotte, NC (US); Traian Morar, Matthews, NC (US)

(21) Appl. No.: 19/147,606

(22) PCT Filed: Jan. 19, 2024
(86) PCT No.: PCT/IB2024/050534

§ 371 Date: Jul. 11, 2025

Related U.S. Application Data
(60) Provisional application No. 63/480,798, filed on Jan. 20, 2023.

(51) Int. Cl. G08B 25/14; A62B 18/08; G08B 7/06; G08B 25/10

(52) U.S. Cl. CPC G08B 25/14; A62B 18/08; G08B 7/06; G08B 25/10

(57) ABSTRACT

A rescue device is disclosed. The rescue device includes a processor; a display communicably coupled to the processor; and a plurality of wireless receivers communicably coupled to the processor. The processor is configured to: receive, via the plurality of wireless receivers, a plurality of signals from a corresponding plurality of location transmitting devices associated with one or more individuals, each signal being indicative of a location of a corresponding location transmitting device in an emergency environment; determine a plurality of locations of the plurality of location transmitting devices based on the plurality of signals, each location being determined based on a corresponding signal from the plurality of signals received from the corresponding location transmitting device; generate a plurality of indicia representing the plurality of locations of the plurality of location transmitting devices; and display, via the display, the plurality of indicia.

### TECHNICAL FIELD

The present disclosure relates generally to a rescue device and a rescue method for rescuing an individual from an emergency environment.

### BACKGROUND

Emergency responders, such as firefighters, often conduct rescue operations to rescue individuals present or trapped in an emergency environment. The emergency responders may need to search and locate the individuals in the emergency environment, which may result in an increase in a time taken to locate the individuals. Under certain hazardous conditions, the increase in the time taken to locate the individuals may significantly reduce a probability of their rescue.

Information regarding locations of the individuals may facilitate the rescue operations, decrease the time taken to locate the individuals, and increase the probability of the rescue of the individuals. Therefore, there is a need for a rescue device that can provide the information regarding the locations of the individuals in the emergency environment to the emergency responders.

### SUMMARY

In a first aspect, the present disclosure provides a rescue device. The rescue device includes a processor. The rescue device further includes a display communicably coupled to the processor. The rescue device further includes a plurality of wireless receivers communicably coupled to the processor. The processor is configured to receive, via the plurality of wireless receivers, a plurality of signals from a corresponding plurality of location transmitting devices associated with one or more individuals. Each signal from the plurality of signals is indicative of a location of a corresponding location transmitting device from the plurality of location transmitting devices in an emergency environment. The processor is further configured to determine a plurality of locations of the plurality of location transmitting devices based on the plurality of signals. Each location from the plurality of locations is determined based on a corresponding signal from the plurality of signals received from the corresponding location transmitting device. The processor is further configured to generate a plurality of indicia representing the plurality of locations of the plurality of location transmitting devices. The processor is further configured to display, via the display, the plurality of indicia.

In a second aspect, the present disclosure provides an article of personal protective equipment (PPE). The article of PPE includes the rescue device of the first aspect.

In a third aspect, the present disclosure provides a rescue method. The rescue method includes receiving, via a plurality of wireless receivers, a plurality of signals from a plurality of location transmitting devices associated with one or more individuals. Each signal from the plurality of signals is indicative of a location of a corresponding location transmitting device from the plurality of location transmitting devices in an emergency environment. The rescue method further includes determining a plurality of locations of the plurality of location transmitting devices based on the plurality of signals. Each location from the plurality of locations is determined based on a corresponding signal from the plurality of signals received from the corresponding location transmitting device. The rescue method further includes generating a plurality of indicia representing the plurality of locations of the plurality of location transmitting devices. The rescue method further includes displaying, via a display, the plurality of indicia.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic block diagram of an exemplary emergency environment;

FIG. 2 is a schematic block diagram of a rescue device according to an embodiment of the present disclosure;

FIG. 3 is schematic diagram of a display of the rescue device according to an embodiment of the present disclosure;

FIGS. 4A and 4B are schematic diagrams of the display according to different embodiments of the present disclosure; and

FIG. 5 is a flowchart depicting various steps of a rescue method according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the present disclosure, the following definitions are adopted.

As recited herein, all numbers should be considered modified by the term “about.” As used herein, “a,” “an,” “the,” “at least one,” and “one or more” are used interchangeably.

As used herein as a modifier to a property or attribute, the term “generally,” unless otherwise specifically defined, means that the property or attribute would be readily recognizable by a person of ordinary skill but without requiring absolute precision or a perfect match (e.g., within +/−20 % for quantifiable properties).

The term “substantially,” unless otherwise specifically defined, means to a high degree of approximation (e.g., within +/−10% for quantifiable properties) but again without requiring absolute precision or a perfect match.

The term “about,” unless otherwise specifically defined, means to a high degree of approximation (e.g., within +/−5% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, when a first material is termed as “similar” to a second material, at least 90% by weight of the first and second materials are identical and any variation between the first and second materials comprises less than about 10% by weight of each of the first and second materials.

As used herein, “at least one of A and B” should be understood to mean “only A, only B, or both A and B.”

As used herein, the term “article of PPE” refers to any article that can be worn by a user for the purpose of preventing or decreasing personal injury or health hazard to the user in or around a hazardous environment. Articles of PPE may include safety glasses, safety goggles, face shields, face masks, respirators, gloves, suits, gowns, aprons, hard hats, powered air purifying respirators (PAPR), self-contained breathing apparatus (SCBA), etc.

As used herein, the term “processor” refers any device that performs logic operations. A processor may include a general processor, a central processing unit, an application specific integrated circuit (ASIC), a digital signal processor, a field programmable gate array (FPGA), a digital circuit, an analog circuit, a controller, a microcontroller, any other type of processor, or any combination thereof.

As used herein, the term “position sensor” refers to any device capable of determining respective positions of one or more objects.

As used herein, the term “emergency environment” refers to an environment, volume, space, region, or area in which an emergency has occurred. For example, an emergency environment may include a burning building, a collapsed building, an environment with exposure to airborne contaminants that may cause adverse health effects, etc. One or more individuals may in the emergency environment may require assistance.

In the following description, alphabetical suffixes are added to various reference numerals for explanatory purposes. It may be noted that an element designated by the reference numeral “10” is equivalent to an element designated by the reference character “10A,” “10B,” and so forth.

The present disclosure provides a rescue device. The rescue device includes a processor. The rescue device further includes a display communicably coupled to the processor. The rescue device further includes a plurality of wireless receivers communicably coupled to the processor. The processor is configured to receive, via the plurality of wireless receivers, a plurality of signals from a corresponding plurality of location transmitting devices associated with one or more individuals. Each signal from the plurality of signals is indicative of a location of a corresponding location transmitting device from the plurality of location transmitting devices in an emergency environment. The processor is further configured to determine a plurality of locations of the plurality of location transmitting devices based on the plurality of signals. Each location from the plurality of locations is determined based on a corresponding signal from the plurality of signals received from the corresponding location transmitting device. The processor is further configured to generate a plurality of indicia representing the plurality of locations of the plurality of location transmitting devices. The processor is further configured to display, via the display, the plurality of indicia.

The rescue device of the present disclosure may aid and assist a user (e.g., an emergency responder, such as a firefighter) carrying the rescue device in locating the plurality of location transmitting devices and the associated one or more individuals in the emergency environment.

The rescue device may utilize the plurality of location transmitting devices (that may be common wireless devices, such as cell phones, RFID tags, and the like) as location beacons. As a result, the rescue device may determine the plurality of locations of the plurality of location transmitting devices and represent the plurality of locations by the plurality of indicia. The rescue device may further display the plurality of indicia to the user via the display in a simple and unobtrusive manner. The user may therefore quickly locate the plurality of individuals in the emergency environment, thereby facilitating their rescue. In some examples, the rescue device may overlay the plurality of indicia on a rescue map of the emergency environment. Therefore, the rescue device may additionally guide the user to the plurality location transmitting devices.

Moreover, the rescue device may determine the individuals related to the emergency environment. Further, the rescue device may determine the individuals that are located in the emergency environment and the individuals that are located outside the emergency environment. This information may facilitate a rescue operation by allowing the user to modify tactics during the rescue operation.

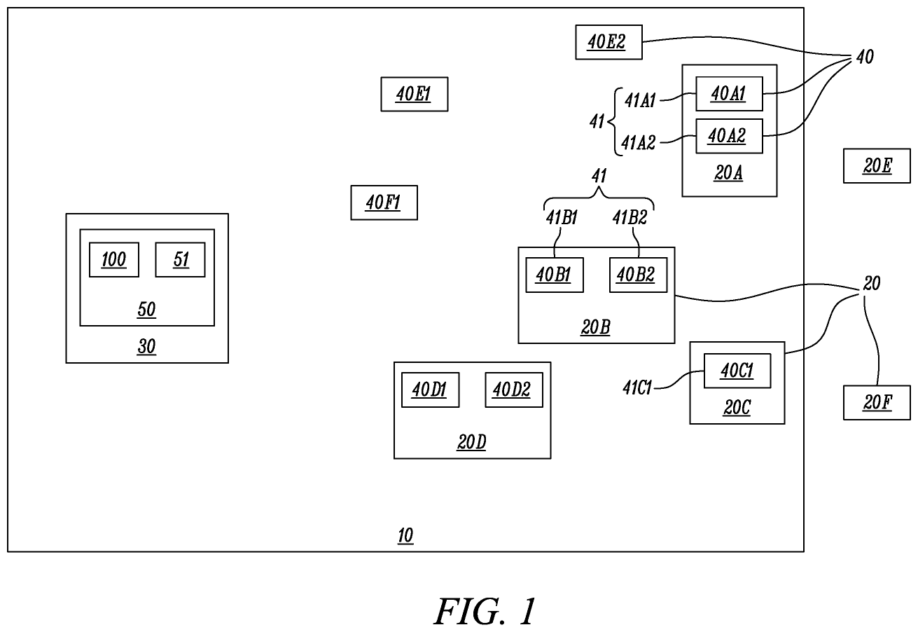

Referring now to the figures, FIG. 1 illustrates a schematic block diagram of an exemplary emergency environment 10.

The emergency environment 10 may include any environment in which an emergency (such as a collapse, fire, chemical or radioactive leak, etc.) has occurred. For example, the emergency environment 10 may include a building on fire, a building that has collapsed, and the like. Emergency responders, such as first responders, police officers, firefighters, emergency medical personnel, and the like, may be summoned to conduct a rescue operation in the emergency environment 10.

The emergency environment 10 may be related to one or more individuals 20. For example, the one or more individuals 20 may be residents of a building that has become the emergency environment 10. Alternatively, the one or more individuals 20 may be non-residents of the building that has become the emergency environment 10. As another example, the one or more individuals 20 may be workers of a factory that has become the emergency environment 10.

At least some of the one or more individuals 20 related to the emergency environment 10 may be located in the emergency environment 10. For example, as shown in FIG. 1, the individuals 20A-20D may be located in the emergency environment 10. In some cases, one or more of the individuals 20A-20D may be trapped in the emergency environment 10 and may require assistance. In some instances, at least some of the one or more individuals 20 related to the emergency environment 10 may be located outside the emergency environment 10. For example, as shown in FIG. 1, the individuals 20E, 20F may be located outside the emergency environment 10.

The emergency environment 10 may further include a plurality of location transmitting devices 40 disposed therein. As will be later discussed in detail, the plurality of location transmitting devices 40 may include any device that is capable of generating a wireless signal indicative of a location thereof. In some embodiments, each location transmitting device 40 may include one of a mobile phone, a wearable device (e.g., a smartwatch), a smart tag (e.g., Apple AirTag), an RFID tag, an alert device (e.g., a personal alert safety system (PASS) device), a portable/mobile radio, and a custom designed transmitting device (e.g., a custom designed transmitting device incorporated in an article of PPE).

The plurality of location transmitting devices 40 may be associated with the one or more individuals 20. For example, the location transmitting devices 40A1, 40A2 may be associated with the individual 20A, the location transmitting devices 40B1, 40B2 may be associated with the individual 20B, and so forth.

In some cases, two or more of the plurality of location transmitting devices 40 may be associated with a single individual 20 from the one or more individuals 20. For example, as shown in FIG. 1, two location transmitting devices 40A1, 40A2 may be associated with the individual 20A. In some other cases, a single location transmitting device 40 from the plurality of location transmitting devices 40 may be associated with a single individual 20 from the one or more individuals 20. For example, a single location transmitting device 40C1 may be associated with the individual 20C.

In some cases, some of the plurality of location transmitting devices 40 may be associated with the one or more individuals 20 that are located outside the emergency environment 10. This may occur, for example, if the one or more individuals 20 that are located outside the emergency environment 10 had abandoned the associated location transmitting devices 40 when leaving the emergency environment 10. For example, the location transmitting devices 40E1, 40E2 may be associated with the individual 20E that is located outside the emergency environment 10, and the location transmitting device 40F1 may be associated with the individual 20F that is located outside the emergency environment 10.

As used herein, a location transmitting device 40 located in the emergency environment 10 is referred to as being “associated” with an individual 20 located in the emergency environment 10 if that location transmitting device 40 can be tracked to determine a location of that individual 20 in the emergency environment 10. On the other hand, a location transmitting device 40 located in the emergency environment 10 is referred to as being “associated” with an individual 20 located outside the emergency environment 10 if that location transmitting device 40 is owned by that individual 20 and is stationary in the emergency environment 10.

For example, the location transmitting devices 40A1, 40A2 located in the emergency environment 10 may be owned and carried by the individual 20A. Therefore, the location transmitting devices 40A1, 40A2 may be associated with the individual 20A. As another example, the location transmitting device 40F1 may be stationarily disposed in the emergency environment 10 and owned by the individual 20F that is located outside the emergency environment 10. In such an example, the location transmitting device 40F1 may be associated with the individual 20F. As yet another example, the location transmitting device 40C1 located in the emergency environment 10 may not be owned by the individual 20C, but carried by the individual 20C. Therefore, the location transmitting device 40C1 may be associated with the individual 20C.

A user 30 may enter the emergency environment 10 for rescuing the one or more individuals 20. The user 30 may be an emergency responder, such as a firefighter. The user 30 may carry a rescue device 100. The rescue device 100 may facilitate the user 30 in rescuing the one or more individuals 20 located in the emergency environment 10. Specifically, the rescue device 100 may aid the user 30 in locating the one or more individuals 20 located in the emergency environment 10.

In some cases, the user 30 may wear an article of personal protective equipment (PPE) 50 when entering the emergency environment 10. The article of PPE 50 may protect the user 30 from one or more hazards present in the emergency environment 10. The article of PPE 50 may include any suitable article that can be donned by the user 30 and that protects the user 30 from the one or more hazards present in the emergency environment 10.

In some embodiments, the article of PPE 50 may include a self-contained breathing apparatus (SCBA), a powered air purifying respirator (PAPR), or a full facepiece respirator. In some embodiments, the article of PPE 50 may include a face mask 51. In some cases, the article of PPE 50 may be worn by the user 30, such that the face mask 51 fully covers a face of the user 30.

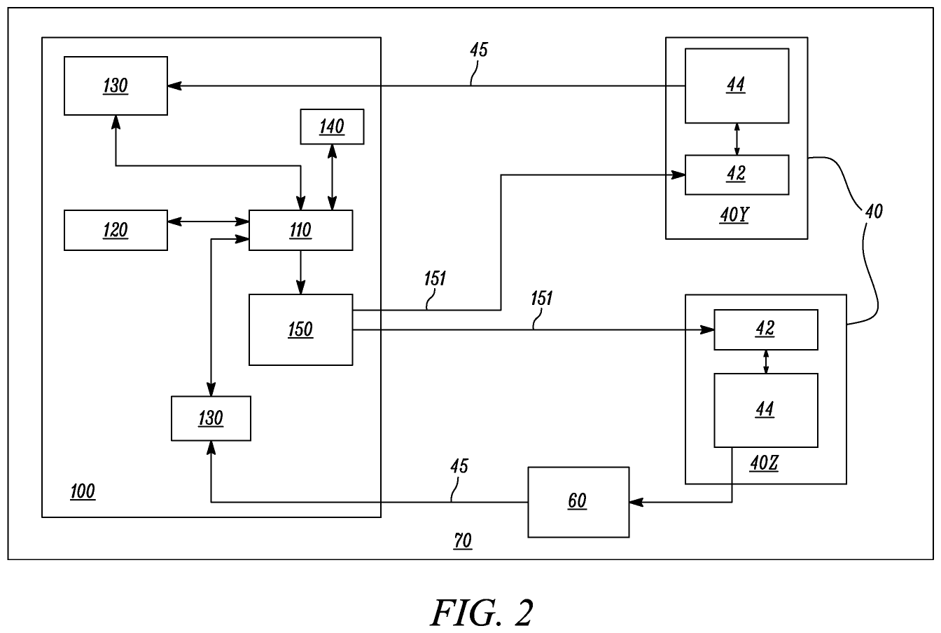

In some embodiments, the article of PPE 50 may include the rescue device 100. The rescue device 100 may be integral with the article of PPE 50. In some other embodiments, the rescue device 100 may be a standalone device. The rescue device 100 and the plurality of location transmitting devices 40 will be further described with reference to FIG. 2.

FIG. 2 illustrates a schematic block diagram of a system 70 according to an embodiment of the present disclosure. The system 70 includes the rescue device 100 and the plurality of location transmitting devices 40.

The rescue device 100 includes a processor 110. The processor 110 may include any device that performs logic operations. For example, the processor 110 may include a general processor, a central processing unit, an application specific integrated circuit (ASIC), a digital signal processor, a field programmable gate array (FPGA), a digital circuit, an analog circuit, a controller, a microcontroller, any other type of processor, or any combination thereof. The rescue device 100 may further include any suitable memory (not shown), such as a volatile memory (e.g., random-access memory (RAM)) and/or a non-volatile memory (e.g., hard disk). The processor 110 may be communicably coupled with the memory. The processor 110 may read from and write to the memory, as required. The memory may be integral with the processor 110 and/or separate from the processor 110.

The rescue device 100 further includes a display 120 communicably coupled to the processor 110. The display 120 may be disposed in a field of view of the user 30. In some embodiments, the display 120 may be used in a head-mounted display (HMD). In some embodiments, the display 120 may be worn on a head of a viewer or may be included as a part of a headgear (e.g., helmet), that has a small display optic in front of an eye, such as in a monocular display device, or two eyes, such as in a binocular display device. In some embodiments, the display 120 may include a heads up display (HUD). In some embodiments, the display 120 may be disposed within the face mask 51 (shown in FIG. 1). For example, the HUD may be disposed within the face mask 51. In some embodiments, the display 120 may be integral with the article of PPE 50. Alternatively, the display 120 may be a standalone device separate from the article of PPE 50.

Each location transmitting device 40 from the plurality of location transmitting devices 40 may include at least one signal generating unit 44. In some cases, each location transmitting device 40 may further include a processor 42, and the at least one signal generating unit 44 may be communicably coupled to the processor 42.

The at least one signal generating unit 44 may be configured to generate a signal 45. The signal 45 may be wirelessly transmitted wirelessly by the corresponding location transmitting device 40. The signal 45 may be indicative of a location of the corresponding location transmitting device 40. In some embodiments, each signal 45 may include one of a wireless signal and an audible signal. The wireless signal may include, for example, a cellular signal, a Bluetooth® signal, an ultrawide band (UWB) signal, a WiFi signal, a long range (LoRa) signal, a near field communication signal, etc. The audible signal may include, for example, an audio tone and an audio chirp.

The system 70 may further include one or more base stations 60 (only one shown in FIG. 2 for illustrative purposes). The one or more base stations 60 may be communicably coupled to the plurality of location transmitting devices 40 via a wireless connection. The one or more base stations 60 and the plurality of location transmitting devices 40 may together form, or be a part of, a wireless network. In some embodiments, the one or more base stations 60 may include one or more servers. In some embodiments, the one or more base stations 60 may include one or more cellular towers.

The one or more base stations 60 may further include information related to the plurality of location transmitting devices 40. For example, the one or more base stations 60 may include ownership information of the plurality of location transmitting devices 40. In other words, the one or more base stations 60 may include information regarding the association of the plurality of location transmitting devices 40 and the individuals 20. The one or more base stations 60 may further include a plot or a map of the emergency environment 10.

The one or more base stations 60 may include any suitable arrangement of transceivers, processing circuitry, and memory. The one or more base stations 60 may be configured to wirelessly communicate with the plurality of location transmitting devices 40. In some cases, the one or more base stations 60 may function as repeaters.

Referring to FIGS. 1 and 2, the rescue device 100 further includes a plurality of wireless receivers 130 communicably coupled to the processor 110. The plurality of wireless receivers 130 may be configured to receive the plurality of signals 45 from the corresponding plurality of location transmitting devices 40 associated with the one or more individuals 20. Each signal 45 from the plurality of signals 45 is indicative of a location of a corresponding location transmitting device 40 from the plurality of location transmitting devices 40 in the emergency environment 10.

In some cases, the processor 110 may directly receive the plurality of signals 45 from the plurality of location transmitting devices 40. For example, as shown in FIG. 2, the processor 110 may directly receive the signal 45 from the location transmitting device 40Y via the wireless receiver 130. In some other cases, the processor 110 may indirectly receive the plurality of signals 45 from the plurality of location transmitting devices 40. For example, as shown in FIG. 2, the processor 110 may indirectly receive the signal 45 from the location transmitting device 40Z via the one or more base stations 60.

The processor 110 is further configured to determine a plurality of locations 41 of the plurality of location transmitting devices 40 based on the plurality of signals 45. For example, the processor 110 may determine the location 41A1 of the location transmitting device 40A1, the location 41A2 of the location transmitting device 40A2, the location 41B1 of the location transmitting device 40B1, the location 41B2 of the location transmitting device 40B2, the location 41C1 of the location transmitting device 40C1, and so forth. Each location 41 from the plurality of locations 41 is determined based on a corresponding signal 45 from the plurality of signals 45 received from the corresponding location transmitting device 40.

In some embodiments, the one or more base stations 60 may include cellular towers that may determine the plurality of locations 41 of the plurality of location transmitting devices 40, for example, by utilizing a trilateration method. Therefore, in some embodiments, the processor 110 may determine the plurality of locations 41 via the one or more base stations 60.

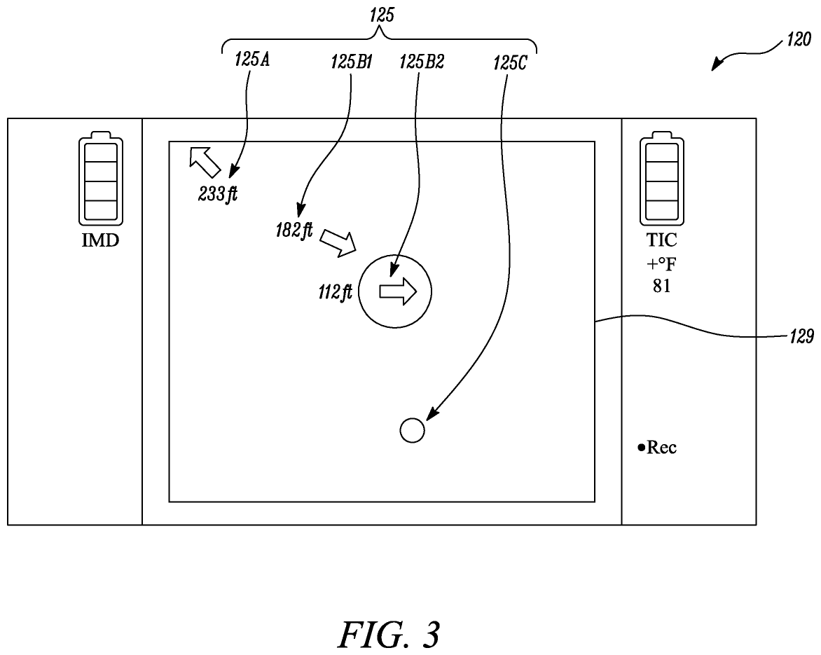

The processor 110 is further configured to generate a plurality of indicia 125 (shown in FIG. 3) representing the plurality of locations 41 of the plurality of location transmitting devices 40. In other words, each indicium 125 from the plurality of indicia 125 may represent the location 41 of the corresponding location transmitting device 40. The processor 110 is further configured to display, via the display 120, the plurality of indicia 125. Each indicium 125 may include any suitable shape, design, and information to represent the location 41 of the corresponding location transmitting device 40.

The processor 110 may be further configured to determine the location 41 of each of the plurality of location transmitting devices 40 during a plurality of recurring time intervals. Therefore, the location 41 of each of the plurality of location transmitting devices 40 may be frequently updated. The processor 110 may update the plurality of indicia 125 illustrate a change in the location 41 of each of the plurality of location transmitting devices 40.

FIG. 3 illustrates a schematic diagram of the display 120 displaying the plurality of indicia 125 according to an embodiment of the present disclosure.

Referring to FIGS. 1 to 3, the rescue device 100 may further include a position sensor 140 communicably coupled to the processor 110. The position sensor 140 may be communicably coupled to the processor 110 via a wired and/or a wireless connection. The position sensor 140 may include any device capable of determining a position of the rescue device 100. In some examples, the position sensor 140 may be configured to determine the position of the rescue device 100 in a spatial reference system (e.g., geographic coordinate system). The position sensor 140 may include, for example, a global positioning system (GPS) sensor, an accelerometer, a compass sensor, a magnetometer, and the like.

The processor 110 may be further configured to determine, via the position sensor 140, a current position of the user 30 carrying the rescue device 100. The processor 110 may be further configured to determine respective distances and respective directions of the plurality of location transmitting devices 40 relative to the current position of the user 30. The plurality of indicia 125 may represent the respective distances and the respective directions of the plurality of location transmitting devices 40. For example, as shown in FIG. 3, the plurality of indicia 125 may include a text to represent the respective distances and a directionality arrow to represent the respective directions of the plurality of location transmitting devices 40 relative to the current position of the user 30.

As an example, the indicium 125A may represent the distance and the respective direction of the location transmitting device 40A1 associated with the individual 20A relative to the current position of the user 30. Further, the indicia 125B1, 125B2 may respectively represent the distances and the respective directions of the location transmitting devices 40B1, 40B2 associated with the individual 20B relative to the current position of the user 30. Each of the indicia 125A, 125B1, 125B2 indicates the distance using text and the direction using an arrow.

The processor 110 may be further configured to determine a change in the location 41 of each of the plurality of location transmitting devices 40 over a predetermined time period. The predetermined time period may be, for example, 30 seconds, 1 minute, etc. The processor 110 may be further configured to determine one or more moving location transmitting devices 40 from the plurality of location transmitting devices 40 based on the change in the location 41 of each of the plurality of location transmitting devices 40. For example, at least one change in the location 41 of one of the location transmitting devices 40 over the predetermined time period may indicate that the one of the location transmitting devices 40 is a moving location transmitting device 40. The one or more moving location transmitting devices 40 may be carried by the individuals 20. Consequently, the locations 41 of the one or more moving location transmitting devices 40 may be analogous with locations of the corresponding associated individuals 20.

The processor 110 may be further configured to highlight one or more indicia 125 from the plurality of indicia 125 corresponding to the one or more locations 41 of the one or more moving location transmitting devices 40. Highlighting the one or more indicia 125 corresponding to the one or more locations 41 of the one or more moving location transmitting devices 40 broadly refers to modifying the one or more indicia 125 in a manner that increases a noticeability thereof.

As an example, the processor 110 may determine that the location transmitting device 40B1 moves over the predetermined time period, and the location transmitting device 40B2 is stationary over the predetermined time period. The processor 110 may therefore highlight (e.g., encircle, as shown in FIG. 3) the indicium 125B1 representing the location 41B1 of the location transmitting device 40B1. Moreover, in some embodiments, the processor 110 may be configured to determine and highlight the indicium 125 corresponding to the signal 45 of the location transmitting device 40 from the plurality of location transmitting devices 40 associated with the individual 20 that has a highest signal quality. The processor 110 may utilize suitable algorithms, look up tables, and the like, to determine the signal 45 that has the highest signal quality. In embodiments where a single location transmitting device 40 may transmit multiple signals 45, the processor 110 may be further configured to highlight the indicium 125 representing the signal 45 having the highest signal quality from the plurality of signals 45.

The processor 110 may be further configured to determine one or more abandoned location transmitting devices 40 from the plurality of location transmitting devices 40 located in the emergency environment 10 and associated with corresponding one or more individuals 20 that are located outside the emergency environment 10. The processor 110 may be further configured to determine that the one or more abandoned location transmitting devices 40 are stationary within the emergency environment 10 for a predetermined time period. In other words, the processor 110 may determine the one or more abandoned location transmitting devices 40 associated with the corresponding one or more individuals 20 that are located outside the emergency environment 10 based on the movement of the one or more abandoned location transmitting devices 40 during the predetermined time period. If the location transmitting device 40 is stationary and associated with the individual 20 located outside the emergency environment 10, the location transmitting device 40 may be determined as the abandoned location transmitting device 40.

The processor 110 may be further configured to disregard the corresponding one or more signals 45 received from the one or more abandoned location transmitting devices 40 when determining the plurality of locations 41 of the plurality of location transmitting devices 40. As an example, the processor 110 may determine that the location transmitting device 40E1 is stationary for the predetermined time period and is associated with the individual 20E that is located outside the emergency environment 10. The processor 110 may therefore disregard the signal 45 received from the location transmitting device 40E1 when determining the plurality of locations 41. Consequently, the processor 110 may not generate any indicia corresponding to the location transmitting device 40E1.

The rescue device 100 may determine the individuals 20 that are located in the emergency environment 10 and the individuals 20 that are located outside the emergency environment 10. This information may be critical in rescuing of the individuals 20 that are located in the emergency environment 10. Further, once the user 30 is certain there is no one left to rescue from the emergency environment 10, the user 30 may exit the emergency environment 10, potentially saving their lives. This information may further be critical when the emergency environment 10 includes hazardous materials (HAZMAT) where the chemical(s) are extremely toxic or reactive.

Moreover, in some embodiments, the processor 110 may be further configured to determine a plurality of quality parameters of the plurality of signals 45. Each quality parameter may be indicative of a signal quality of a corresponding signal 45 from the plurality of signals 45. The processor 110 may be further configured to compare the plurality of quality parameters with a corresponding plurality of quality thresholds. The processor 110 may be further configured to determine one or more low quality signals 45 from the plurality of signals 45 whose corresponding one or more quality parameters are less than the corresponding one or more quality thresholds. The processor 110 may be further configured to disregard the one or more low quality signals 45 when determining the plurality of locations 41 of the plurality of location transmitting devices 40. The one or more low quality signals 45 may indicate erroneous locations, and therefore may be disregarded while determining the plurality of locations 41. Consequently, the processor 110 may not represent the erroneous locations via the plurality of indicia 125.

In some embodiments, the processor 110 may be further configured to generate a rescue map 129 of the emergency environment 10. The rescue map 129 is schematically illustrated by a rectangular block in FIG. 3. The rescue map 129 may include various information regarding the emergency environment 10, for example, information relating to floors, entry points, exit points, and paths to navigate in the emergency environment 10.

The rescue map 129 may be preinstalled in the rescue device 100 before the user 30 enters the emergency environment 10. Alternatively, the rescue map 129 may be automatically downloaded from the one or more base stations 60. The one or more base stations 60 of many IoT enabled buildings may include plots and maps thereof that can be wirelessly accessed via the rescue device 100.

The processor 110 may be further configured to overlay the plurality of indicia 125 on the rescue map 129. For example, as shown in FIG. 3, the plurality of indicia 125 may be overlaid on the rescue map 129. In some embodiments, the plurality of indicia 125 may be overlaid on the rescue map 129 corresponding to the locations 41 of the location transmitting devices 40. As an example, the indicium 125C may be overlaid on the rescue map 129 corresponding to the location 41B1 of the location transmitting device 40B1. The indicum 125C includes a dot or a circle in the rescue map 129. Therefore, the rescue map 129 may facilitate the user 30 in navigating the emergency environment 10 and rescuing the individuals 20.

The rescue device 100 may be configured to operate in both a passive manner and an active manner. Specifically, the rescue device 100 may passively detect the plurality of location transmitting devices 40 and determine the respective locations 41 thereof. In other words, the rescue device 100 may determine the plurality of locations 41 based on the plurality of signals 45 generated by the plurality of location transmitting devices 40 without generating and transmitting any signal to the plurality of location transmitting devices 40.

Furthermore, the rescue device 100 may actively cause the plurality of location transmitting devices 40 to generate the corresponding plurality of signals 45, such that the respective locations 41 thereof may be determined. The rescue device 100 may further include a wireless alert unit 150 communicably coupled to the processor 110. The processor 110 may be further configured to generate a plurality of alert signals 151. The processor 110 may be further configured to transmit the plurality of alert signals 151 to the plurality of location transmitting devices 40, such that upon receiving the plurality of alert signals 151, the plurality of location transmitting devices may generate and transmit the plurality of signals 45.

Upon receiving the plurality of alert signals 151, the plurality of location transmitting devices 40 may transition into an emergency mode. For example, upon receiving the plurality of alert signals 151, cell phones may transition into “Find My Phone” mode, thereby generating and transmitting the plurality of signals 45. In some cases, the plurality of signals 45 generated by the plurality of location transmitting devices 40 may include audible signals. The audible signals may further aid the user 30 in locating the plurality of location transmitting devices 40. In some embodiments, the rescue device 100 may determine the locations 41 of the plurality of location transmitting devices 40 based on the audible signals.

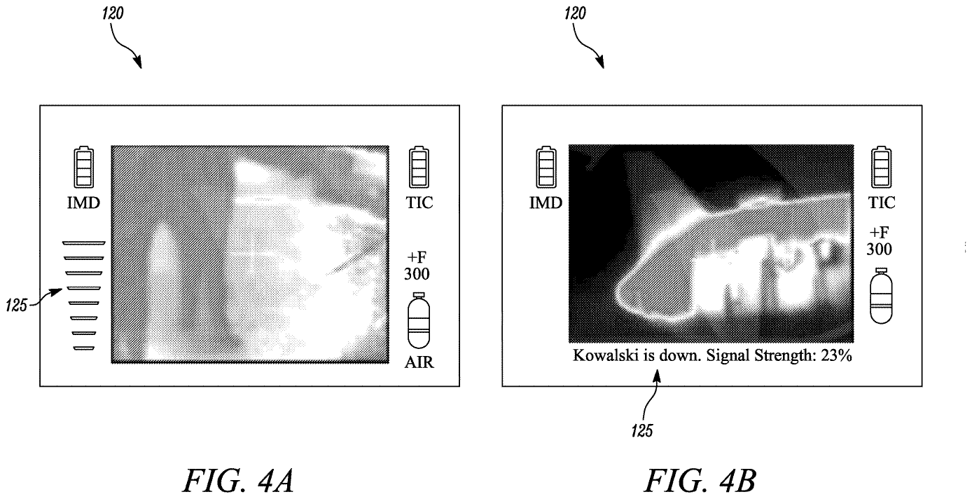

FIGS. 4A and 4B illustrate schematic diagrams of the display 120 displaying the plurality of indicia 125 according to different embodiments of the present disclosure.

Referring to FIGS. 1, 2, 4A, and 4B, the processor 110 may be further configured to determine a plurality of signal strengths of the plurality of signals 45. Specifically, the processor 110 may determine the signal strength of each signal 45. Further, the plurality of indicia 125 may represent the plurality of signal strengths of the plurality of signals 45.

For example, the plurality of indicia 125 may represent the plurality of signal strengths as a plurality of graduated bars. In the example shown in FIG. 4A, the plurality of indicia 125 represents a signal strength from the plurality of signal strengths as a graduated bar. In one example, the signal strength represented in FIG. 4A may be of the signal 45 of the location transmitting device 40 located closest to the rescue device 100. In another example, the signal strength represented in FIG. 4A may be of the signal 45 of the location transmitting device 40 manually selected by the user 30.

As shown in FIG. 4B, the plurality of indicia 125 may represent the plurality of signal strengths of the plurality of signals 45 by text. In the example shown in FIG. 4B, the plurality of indicia 125 represents a signal strength from the plurality of signal strengths by text. Specifically, in FIG. 4B, the signal strength is represented in text as a percentage. Further, as shown in FIG. 4B, the plurality of indicia 125 may further represent information regarding the associated individual 20 (e.g., their name, status, etc.).

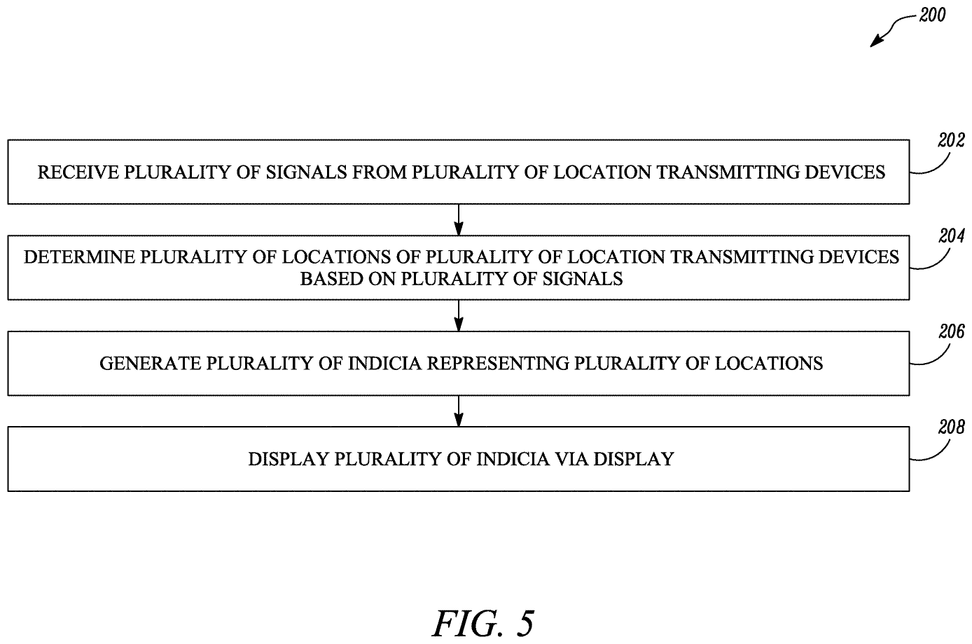

FIG. 5 illustrates a flowchart of a rescue method 200 according to an embodiment of the present disclosure. The rescue method 200 may be employed by the processor 110 of the rescue device 100 (shown in FIG. 2). The rescue method 200 will be described with reference to FIGS. 1, 2, 3, and 5.

At step 202, the rescue method 200 includes receiving, via a plurality of wireless receivers, a plurality of signals from a plurality of location transmitting devices associated with one or more individuals. Each signal from the plurality of signals is indicative of a location of a corresponding location transmitting device from the plurality of location transmitting devices in an emergency environment. For example, the rescue method 200 may include receiving the plurality of signals 45 from the plurality of location transmitting devices 40.

At step 204, the rescue method 200 includes determining a plurality of locations of the plurality of location transmitting devices based on the plurality of signals. Each location from the plurality of locations is determined based on a corresponding signal from the plurality of signals received from the corresponding location transmitting device. For example, the rescue method 200 may include determining the plurality of locations 41 of the plurality of location transmitting devices 40 based on the plurality of signals 45.

At step 206, the rescue method 200 includes generating a plurality of indicia representing the plurality of locations of the plurality of location transmitting devices. For example, the rescue method 200 may include generating the plurality of indicia 125 representing the plurality of locations 41 of the plurality of location transmitting devices 40.

At step 208, the rescue method 200 includes displaying, via a display, the plurality of indicia. For example, the rescue method 200 may include displaying the plurality of indicia 125 via the display 120.

In some embodiments, the rescue method 200 may further include determining, via a position sensor, a current position of a user. The rescue method 200 may further include determining respective distances and respective directions of the plurality of location transmitting devices relative to the current position of the user. For example, the rescue method 200 may further include determining the current position of the user 30 via the position sensor 140.

In some embodiments, the plurality of indicia may represent the respective distances and the respective directions of the plurality of location transmitting devices. For example, as shown in FIG. 3, the plurality of indicia 125 may represent the respective distances and the respective directions of the plurality of location transmitting devices 40.

In some embodiments, the rescue method 200 may further include determining a plurality of signal strengths of the plurality of signals. The plurality of indicia may represent the plurality of signal strengths of the plurality of signals. For example, as shown in FIGS. 4A and 4B, the plurality of indicia 125 may represent the plurality of signal strengths of the plurality of signals 45.

In some embodiments, the rescue method 200 may further include generating a rescue map of the emergency environment. The rescue method 200 may further include overlaying the plurality of indicia on the rescue map. For example, the rescue method 200 may further include overlaying the plurality of indicia 125 (e.g., the indicium 129C in FIG. 3) on the rescue map 129.

In some embodiments, the rescue method 200 may further include determining the location of each of the plurality of location transmitting devices during a plurality of recurring time intervals. For example, the rescue method 200 may include determining the location 41 of each of the plurality of location transmitting devices 40 during the plurality of recurring time intervals.

In some embodiments, the rescue method 200 may further include determining a change in the location of each of the plurality of location transmitting devices over a predetermined time period. The rescue method 200 may further include determining one or more moving location transmitting devices from the plurality of location transmitting devices based on the change in the location of each of the plurality of location transmitting devices. The rescue method 200 may further include highlighting one or more indicia from the plurality of indicia corresponding to the one or more locations of the one or more moving location transmitting devices.

For example, the rescue method 200 may include determining the one or more moving location transmitting devices 40 from the plurality of location transmitting devices 40 based on the change in the location 41 of each of the plurality of location transmitting devices 40. As shown in FIG. 3, the rescue method 200 may further include highlighting one or more indicia 125 (e.g., the indicium 125B2 in FIG. 3) from the plurality of indicia 125 corresponding to the one or more locations 41 of the one or more moving location transmitting devices 40.

In some embodiments, the rescue method 200 may further include determining one or more abandoned location transmitting devices from the plurality of location transmitting devices located in the emergency environment and associated with corresponding one or more individuals that are located outside the emergency environment. The rescue method 200 may further include disregarding the corresponding one or more signals received from the one or more abandoned location transmitting devices when determining the plurality of locations of the plurality of location transmitting devices. For example, the rescue method 200 may include determining the one or more abandoned location transmitting devices 40 (e.g., the location transmitting device 40E1 in FIG. 1) located in the emergency environment 10 and associated with corresponding one or more individuals 20 (e.g., 20E in FIG. 1) that are located outside the emergency environment 10. Further, the rescue method 200 may include disregarding the corresponding one or more signals 45 received from the one or more abandoned location transmitting devices 40 when determining the plurality of locations 41 of the plurality of location transmitting devices 40.

In some embodiments, determining the one or more abandoned location transmitting devices further may include determining that the one or more abandoned location transmitting devices are stationary within the emergency environment for a predetermined time period. For example, determining the one or more abandoned location transmitting devices 40 may further include determining that the one or more abandoned location transmitting devices 40 are stationary within the emergency environment 10 for the predetermined time period.

In some embodiments, the rescue method 200 may further include determining a plurality of quality parameters of the plurality of signals. Each quality parameter may be indicative of a signal quality of a corresponding signal from the plurality of signals. The rescue method 200 may further include comparing the plurality of quality parameters with a corresponding plurality of quality thresholds. The rescue method 200 may further include determining one or more low quality signals from the plurality of signals whose corresponding one or more quality parameters are less than the corresponding one or more quality thresholds. The rescue method 200 may further include disregarding the one or more low quality signals when determining the plurality of locations of the plurality of location transmitting devices.

For example, the rescue method 200 may include determining the plurality of quality parameters of the plurality of signals 45, comparing the plurality of quality parameters with the corresponding plurality of quality thresholds, determining the one or more low quality signals 45 from the plurality of signals 45 whose corresponding one or more quality parameters are less than the corresponding one or more quality thresholds, and disregarding the one or more low quality signals 45 when determining the plurality of locations 41 of the plurality of location transmitting devices 40.

In some embodiments, the rescue method 200 may further include generating a plurality of alert signals. The rescue method 200 may further include transmitting, via a wireless alert unit, the plurality of alert signals to the plurality of location transmitting devices, such that upon receiving the plurality of alert signals, the plurality of location transmitting devices generates and transmits the plurality of signals. For example, the rescue method 200 may include generating the plurality of alert signals 151, transmitting the plurality of alert signals 151 to the plurality of location transmitting devices 40 via the wireless alert unit 150, such that upon receiving the plurality of alert signals 151, the plurality of location transmitting devices 40 may generate and transmit the plurality of signals 45.

In some embodiments, each location transmitting device may include one of a mobile phone, a wearable device, a smart tag, an RFID tag, a personal alert safety system (PASS) device, a mobile radio, and a custom designed transmitting device. In some embodiments, each signal may include one of a wireless signal and an audible signal. For example, each location transmitting device 40 may include one of a mobile phone, a wearable device, a smart tag, an RFID tag, an alert device (e.g., a personal alert safety system (PASS) device), a portable/mobile radio, and a custom designed transmitting device (e.g., a custom designed transmitting device incorporated in an article of PPE). Further, each signal 45 may include one of a wireless signal and an audible signal.

The rescue method 200 may facilitate a user in locating one or more individuals in an emergency environment, thereby increasing a probability of a rescue of the one or more individuals from the emergency environment.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A rescue device comprising:
a processor;
a position sensor communicably coupled to the processor;
a display communicably coupled to the processor; and
a plurality of wireless receivers communicably coupled to the processor;
wherein the processor is configured to:
receive, via the plurality of wireless receivers, a plurality of signals from a corresponding plurality of location transmitting devices associated with one or more individuals, wherein each signal from the plurality of signals is indicative of a location of a corresponding location transmitting device from the plurality of location transmitting devices in an emergency environment;
determine, via the position sensor, a current position of the rescue device as the rescue device moves through the emergency environment;
determine a plurality of locations of the plurality of location transmitting devices based on the plurality of signals, wherein each location from the plurality of locations is determined based on a corresponding signal from the plurality of signals received from the corresponding location transmitting device;
determine respective distances and respective directions of the plurality of location transmitting devices relative to the current position of the rescue device;
generate a plurality of indicia representing the plurality of locations of the plurality of location transmitting devices, wherein the plurality of indicia represents the respective distances and the respective directions relative to the current position of the rescue device; and
display, via the display, the plurality of indicia, wherein the plurality of indicia is updated based on changes in the current position of the rescue device as the rescue device moves through the emergency environment.

2-3. (canceled)

4. The rescue device of claim 1, wherein the processor is further configured to determine a plurality of signal strengths of the plurality of signals, wherein the plurality of indicia represents the plurality of signal strengths of the plurality of signals.

5. The rescue device of claim 1, wherein the processor is further configured to:
generate a rescue map of the emergency environment; and
overlay the plurality of indicia on the rescue map.

6. The rescue device of claim 1, wherein the processor is further configured to determine the location of each of the plurality of location transmitting devices during a plurality of recurring time intervals.

7. The rescue device of claim 1, wherein the processor is further configured to:
determine a change in the location of each of the plurality of location transmitting devices over a predetermined time period;
determine one or more moving location transmitting devices from the plurality of location transmitting devices based on the change in the location of each of the plurality of location transmitting devices; and
highlight one or more indicia from the plurality of indicia corresponding to the one or more locations of the one or more moving location transmitting devices

8. The rescue device of claim 1, wherein the processor is further configured to:
determine one or more abandoned location transmitting devices from the plurality of location transmitting devices located in the emergency environment and associated with corresponding one or more individuals that are located outside the emergency environment; and
disregard the corresponding one or more signals received from the one or more abandoned location transmitting devices when determining the plurality of locations of the plurality of location transmitting devices.

9. The rescue device of claim 4, wherein the processor is further configured to determine that the one or more abandoned location transmitting devices are stationary within the emergency environment for a predetermined time period.

10. The rescue device of claim 1, wherein the processor is further configured to:
determine a plurality of quality parameters of the plurality of signals, wherein each quality parameter is indicative of a signal quality of a corresponding signal from the plurality of signals;
compare the plurality of quality parameters with a corresponding plurality of quality thresholds;
determine one or more low quality signals from the plurality of signals whose corresponding one or more quality parameters are less than the corresponding one or more quality thresholds; and
disregard the one or more low quality signals when determining the plurality of locations of the plurality of location transmitting devices.

11. The rescue device of claim 1, further comprising a wireless alert unit communicably coupled to the processor, wherein the processor is further configured to:
generate a plurality of alert signals; and
transmit the plurality of alert signals to the plurality of location transmitting devices, such that upon receiving the plurality of alert signals, the plurality of location transmitting devices generates and transmits the plurality of signals.

12. The rescue device of claim 1, wherein each location transmitting device comprises one of a mobile phone, a wearable device, a smart tag, an RFID tag, a personal alert safety system (PASS) device, and a mobile radio.

13. The rescue device of claim 1, wherein each signal comprises one of a wireless signal and an audible signal.

14. An article of personal protective equipment (PPE) comprising the rescue device of claim 1.

15. The article of PPE of claim 14, further comprising a face mask, wherein the display is disposed within the face mask.

16. The article of PPE of claim 14, comprising a self-contained breathing apparatus (SCBA), a powered air purifying respirator (PAPR), or a full facepiece respirator.

17. A rescue method comprising:
determining, via a position sensor, a current position of a rescue device as the rescue device moves through an emergency environment;
receiving, via a plurality of wireless receivers, a plurality of signals from a plurality of location transmitting devices associated with one or more individuals, wherein each signal from the plurality of signals is indicative of a location of a corresponding location transmitting device from the plurality of location transmitting devices in the emergency environment;
determining a plurality of locations of the plurality of location transmitting devices based on the plurality of signals, wherein each location from the plurality of locations is determined based on a corresponding signal from the plurality of signals received from the corresponding location transmitting device;
determining respective distances and respective directions of the plurality of location transmitting devices relative to the current position of the rescue device;
generating a plurality of indicia representing the plurality of locations of the plurality of location transmitting devices, wherein the plurality of indicia represents the respective distances and the respective directions relative to the current position of the rescue device; and
displaying, via a display, the plurality of indicia, wherein the plurality of indicia is updated based on changes in the current position of the rescue device as the rescue device moves through the emergency environment.

18. The rescue method of claim 17, further comprising:
determining a change in the location of each of the plurality of location transmitting devices over a predetermined time period;
determining one or more moving location transmitting devices from the plurality of location transmitting devices based on the change in the location of each of the plurality of location transmitting devices; and
highlighting one or more indicia from the plurality of indicia corresponding to the one or more locations of the one or more moving location transmitting devices.

19. The rescue method of claim 17, further comprising:
determining a plurality of signal strengths of the plurality of signals, wherein the plurality of indicia represents the plurality of signal strengths of the plurality of signals as graduated bars or text displayed on the display.

20. The rescue method of claim 17, further comprising:
generating a rescue map of the emergency environment; and overlaying the plurality of indicia on the rescue map, wherein the plurality of indicia is overlaid on the rescue map at positions corresponding to the plurality of locations of the plurality of location transmitting devices relative to the current position of the rescue device.
